(19) United States
(12) Patent Application Publication
(10) Pub. No.: US 2009/0154870 A1
(43) Pub. Date: Jun. 18, 2009

(54) Optical Fiber Sensor Connected To Optical Fiber Communication Line

(76) Inventors: Kazuhiro Watanabe, Kanagawa (JP); Hiroyuki Sasaki, Tokyo (JP)

Correspondence Address: BIRCH STEWART KOLASCH & BIRCH, PO BOX 747, FALLS CHURCH, VA, 22040-0747, US

(21) Appl. No.: 11/989,778

(22) PCT Filed: Apr. 28, 2006
(86) PCT No.: PCT/JP2006/309014

§ 371 Date: Jun. 18, 2008

(30) Foreign Application Priority Data
Aug. 1, 2005 (JP) 2005-222797

(51) Int. Cl. G02B 6/00

(52) U.S. Cl. 385/12

(57) ABSTRACT

An optical fiber sensor connected to an optical fiber communication line usable on an optical fiber communication line of the Internet etc. and able to share a communication line and a sensor line is provided. It has an optical fiber sensor line being an optical fiber (11d, 11b, 11e) provided with a core and with a cladding provided on an outer circumference of the core and provided so as to be optically coupled with the optical fiber communication line (10, 11a), which has a sensor portion (SPa, SPb, SPc, SPd) for enabling interaction of a portion of transmitted light with an external environment and includes a portion 11b for transmitting at least communication light from the optical fiber communication line; a light source (17) emitting sensor light to an incident end of the optical fiber sensor line; and a light receiving portion (18) detecting the sensor light emitted from an emitting end of the optical fiber sensor line via the sensor portion.

### TECHNICAL FIELD

The present invention relates to an optical fiber sensor connected to an optical fiber communication line, more particularly relates to an optical fiber sensor connected to an optical fiber communication line forming part of the Internet etc.

### BACKGROUND ART

Optical fiber sensors are being widely used as security system sensors, pressure sensors, etc. for buildings.

Japanese Patent Publication (B2) No. 2003-532140 discloses an optical fiber sensor called an “FBG (Fiber Bragg Grating)”.

An FBG is a variable optical filter designed so as to transmit or reflect light having a specific wavelength according to Bragg's principle.

Further, the document (Multifunctional fiber-optics networks for composite structure, Proceedings of SPIE, Vol. 5391, pp. 741-752) reports an experiment using the above FBG on an optical fiber communication line.

However, when using an FBG optical fiber sensor on an optical fiber communication line as disclosed in the above document, the FBG measures the wavelength shift, so the overall apparatus becomes complex and expensive. Further, the characteristics depend on the temperature, therefore temperature compensation is necessary as well. It is necessary to overcome various problems in order to actually use this apparatus.

Concerning the optical fiber sensor described above, a design using a so-called hetero core portion as the sensor is disclosed in the pamphlet of International Publication No. 97/48994 and Japanese Patent Publication (A) No. 2003-214906.

Further, in the pamphlet of International Publication No. 97/48994 and Japanese Patent Publication No. 2003-214906, there is no description of the use of this on optical fiber communication lines of the Internet etc.

### DISCLOSURE OF THE INVENTION

### Problem to be Solved by the Invention

The problem to be solved is that it difficult to use an optical fiber sensor on an optical fiber communication line of the Internet etc. and share a communication line and a sensor line.

### Means for Solving the Problem

An optical fiber sensor connected to an optical fiber communication line of the present invention has an optical fiber sensor line being an optical fiber provided with a core and with a cladding provided on an outer circumference of the core and provided so as to be optically coupled with the optical fiber communication line, which has a sensor portion for enabling interaction of a portion of transmitted light with an external environment and includes a portion for transmitting at least communication light from the optical fiber communication line; a light source emitting sensor light to an incident end of the optical fiber sensor line; and a light receiving portion detecting the sensor light emitted from an emitting end of the optical fiber sensor line via the sensor portion.

The optical fiber sensor connected to an optical fiber communication line of the present invention described above has an optical fiber being provided with a core and with a cladding provided on an outer circumference of the core and provided so as to be optically coupled with the optical fiber communication line.

Here, the above optical fibers form an optical fiber sensor line having a sensor portion for enabling interaction of a portion of the transmitted light with the external environment and including a portion for transmitting at least communication light from the optical fiber communication line.

Further, the sensor has a light source emitting sensor light to the incident end of the optical fiber sensor line and a light receiving portion detecting the sensor light emitted from an emitting end of the optical fiber sensor line via the sensor portion.

In the optical fiber sensor connected to an optical fiber communication line of the present invention described above, preferably the sensor portion is a hetero core portion having a core diameter different from the core diameter of the optical fiber and is joined to a middle portion of the optical fibers.

Alternatively, preferably, the sensor portion is designed having a light transmission member having a refractive index equivalent to the refractive index of the core of the optical fibers or the refractive index of the cladding joined to the middle portion of the optical fibers.

The optical fiber sensor connected to an optical fiber communication line of the present invention described above preferably further has on the optical fiber sensor line an optical coupler for combining the sensor light from the light source and the communication light from the optical fiber communication line.

Further, preferably, wavelengths of the communication light and the sensor light are different.

The optical fiber sensor connected to an optical fiber communication line of the present invention described above preferably further has on the optical fiber sensor line an optical splitter for splitting the light, sending the sensor light to the light receiving portion, and sending the communication light to a communication apparatus.

Alternatively, preferably the incident end and emitting end are the same end portion of the optical fibers, and the light receiving portion detects backward scattering light from the sensor portion.

In the optical fiber sensor connected to an optical fiber communication line of the present invention described above, preferably the optical fiber communication line is the Internet.

Further, preferably, the optical fiber communication line is used as the light source, and the communication light from the optical fiber communication line is used as it is as the sensor light.

### EFFECT OF THE INVENTION

In the optical fiber sensor connected to an optical fiber communication line of the present invention, the optical fiber sensor can be used on an optical fiber communication line of the Internet etc., and the communication line and the sensor line can be shared.

### BRIEF DESCRIPTION OF THE DRAWINGS

FIG. 1 is a schematic view of the configuration of an optical fiber sensor connected to an optical fiber communication line according to a first embodiment of the present invention.

FIG. 2A is a perspective view of the vicinity of a sensor portion SP of an optical fiber for showing an example of the constitution of the sensor portion, and FIG. 2B is a sectional view in a longitudinal direction of the vicinity of the sensor portion.

FIG. 3A and FIG. 3B are sectional views in the longitudinal direction of the vicinity of sensor portions of optical fibers for showing an example of the constitution of the sensor portion.

FIG. 4 is a schematic view of the configuration of an optical fiber sensor connected to an optical fiber communication line according to a second embodiment of the present invention.

FIG. 5 is a schematic view of the configuration of an optical fiber sensor connected to an optical fiber communication line according to a third embodiment of the present invention.

### DESCRIPTION OF NOTATIONS

3 . . . hetero core portion, 4 . . . interface, 10 . . . Internet, 11a . . . first optical fiber, 11b . . . second optical fiber, 11c . . . third optical fiber, 11d . . . fourth optical fiber, 11e . . . fifth optical fiber, 12, 12a . . . connection apparatuses, 13 . . . personal computer, 14 . . . optical coupler, 15 . . . ODTR measurement unit, 16 . . . optical splitter, 17 . . . light source, 18 . . . light receiving portion, 20a, 20b . . . optical fibers, 21, 31 . . . cores, 22, 32 . . . claddings, 30 . . . light transmission member, SP, SPa, SPb, SPc, SPd, SPe, SPf . . . sensor portions, and W . . . leakage light.

### BEST MODE FOR CARRYING OUT THE INVENTION

Below, embodiments of an optical fiber sensor connected to an optical fiber communication line of the present invention will be explained with reference to the drawings.

### First Embodiment

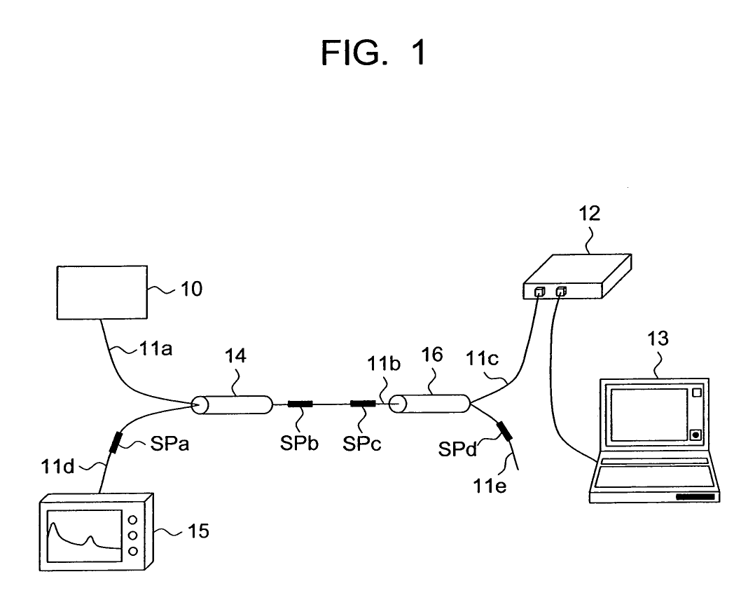

FIG. 1 is a schematic view of the configuration of an optical fiber sensor connected to an optical fiber communication line according to a first embodiment of the present invention.

For example, a first optical fiber 11a, second optical fiber 11b, and third optical fiber 11c are provided connected to the international optical fiber communication network, that is, the Internet 10, a media computer or modem or other connection apparatus 12 is provided at an end portion of the third optical fiber 11c, and a personal computer 13 is connected to the connection apparatus 12. In this case, the first optical fiber 11a, second optical fiber 11b, and third optical fiber 11c constitute the optical fiber communication line. The personal computer 13 is connected to the Internet 10 via this in this constitution.

For example, between the Internet 10 and the personal computer 13, communication light having wavelengths of 1.31 μm and 1.49 μm are transferred via the first optical fiber 11a, second optical fiber 11b, and third optical fiber 11c whereby information communication is carried out.

In the above description, an optical coupler 14 is provided at the connection portion of the first optical fiber 11a and the second optical fiber 11b, a fourth optical fiber 11d is connected, and an ODTR (Optical Time Domain Reflectometer) measurement unit 15 is connected. The OTDR measurement unit 15 is an apparatus for measuring loss etc. of the optical fiber by utilizing backward scattering light.

Further, an optical splitter 16 is provided at the connection portion of the second optical fiber 11b and third optical fiber 11c, and a fifth optical fiber 11e is connected. The fifth optical fiber 11e is connected to a not shown optical fiber, connection apparatus, etc.

Here, on the fourth optical fiber 11d, second optical fiber 11b, and fifth optical fiber 11e, sensor portions (SPa, SPb, SPc, SPd) are provided, whereby the optical fiber sensor line is formed. Namely, the second optical fiber 11b is shared by the optical fiber communication line and the optical fiber sensor line in this constitution.

The ODTR measurement unit 15 has for example a built-in laser diode or light emitting diode, emits sensor light having a wavelength different from that of the communication light, that is, a wavelength of 1.55 μm, and makes this strike the incident end of the fourth optical fiber 16d.

The sensor light is combined with the communication light transmitted from the first optical fiber 11a at the optical coupler 14 and transmitted to the second optical fiber 11b.

After the combined sensor light and communication light are transmitted through the second optical fiber 11b, the optical splitter 16 transmits the sensor light to the fifth optical fiber 11e side, while transmits the communication light to the connection apparatus 12 through the third optical fiber 11c.

The wavelengths of the communication light and sensor light differ as described above, therefore combining these at the optical coupler and splitting these at the optical splitter become possible.

The ODTR measurement unit 15 emits the sensor light and, at the same time, receives backward scattering light from sensor portions (SPa to SPd). Namely, in the present embodiment, the incident end and emitting end of the sensor light are the same end portion as the optical fiber sensor, the ODTR measurement unit 15 acting as the light receiving portion detects backward scattering light from the sensor portions (SPa to SPd), and the information to be measured at sensor portions (SPa to SPd) are obtained. In particular, in the measurement at the OTDR measurement unit 15, a plurality of sensor portions can be arranged in series on the sensor line. This is due to the fact that from which position of sensor portion the light is scattered can be discriminated by measurement by backward scattering light.

An explanation will be given of optical fibers and sensor portions constituting the optical fiber sensor line described above.

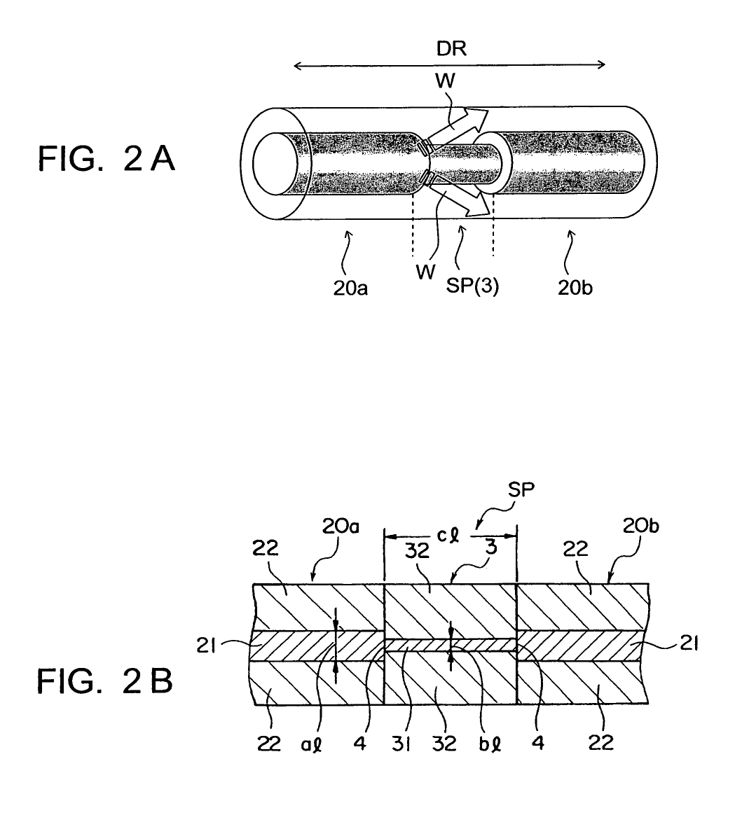

FIG. 2A is a perspective view of the vicinity of the sensor portion SP of optical fibers (20a, 20b) for showing an example of the constitution of the sensor portion SP, and FIG. 2B is a sectional view in a longitudinal direction of the vicinity of the sensor portion SP.

For example, it is assumed that each optical fiber constituting the optical fiber sensor line has the same constitution as that of an optical fiber of the optical fiber communication line, that is, is a single mode fiber having a core diameter of for example 9 μm, and that a sensor portion SP is provided between one optical fiber 20a and the other optical fiber 20b.

Each optical fiber (20a, 20b) has a core 21 and a cladding 22 provided at its outer circumference. The light transmitted from the light source is made incident upon the core 21 from the light incident end side and emitted from the core 21 on the light emitting end side to the light receiving portion via the sensor portion SP.

The sensor portion SP shown in FIG. 2A and FIG. 2B is a hetero core portion 3 having a core diameter different from the core diameter of the optical fibers (20a, 20b) and has a core 31 and a cladding 32 provided on its outer circumference.

A diameter bl of the core 31 in the hetero core portion 3 is smaller than a diameter al of the core 21 of the optical fibers (20a, 20b). For example, al=9 μm, and bl=5 μm. Further, a length cl of the hetero core portion 3 is a few micrometers to a few centimeters and for example is about 1 mm.

The optical fibers (20a, 20b) and the hetero core portion 3 constituting the sensor portion SP are substantially coaxially joined so that cores are joined to each other at interfaces 4 perpendicular to the longitudinal direction by for example the common technique of fusion splicing by electrodischarge.

As shown in FIG. 2A and FIG. 2B, in a configuration were the sensor portion SP is joined to the middle portion of the optical fibers (20a, 20b), the diameter bl of the core 31 in the hetero core portion 3 and the diameter al of the core 21 of the optical fiber (20a, 20b) are different at the interface 4. A portion of the light W is leaked to the cladding 32 of the hetero core portion 3 due to this difference of core diameters. When the combination of diameters of the core 21 and core 31 is selected so as to reduce the leakage W, most of the light is incident upon the optical fiber 21 again and transmitted. At this time, an insertion loss of the sensor is small, and a degree of the leakage W sharply changes according to bending or other external environment change. Further, according to some combinations of diameters of the core 21 and core 31, the leakage W can be made extremely large as well. In this case, the many lights of leakage W generate evanescent waves at the interfaces between the cladding 32 and the external environment. These waves act upon the external environment, and enable changes to be picked up.

The light leaked as described above changes in accordance with the degree of bending of the optical fibers at the sensor portion SP and the environment in which the optical fibers are placed. Therefore, the information to be measured at the sensor portion SP can be obtained by sensing a change occurring as a result of interaction with the external environment.

As the sensor portion SP, other configurations can be employed as well.

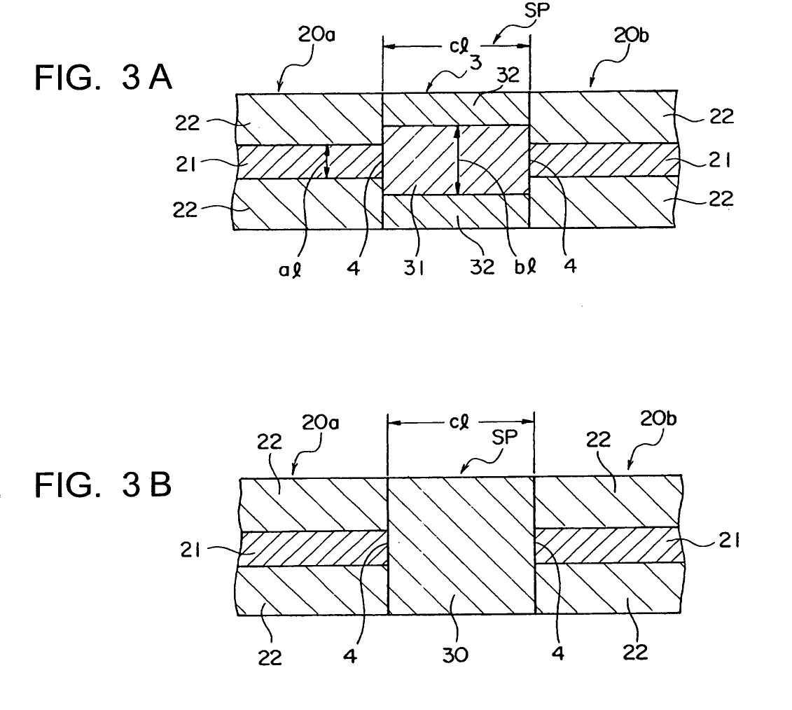

FIG. 3A and FIG. 3B are sectional views in the longitudinal direction of the vicinity of sensor portions SP of optical fibers (20a, 20b) for showing an example of the configuration of sensor portions SP.

In FIG. 3A, the diameter bl of the core 31 of the hetero core portion 3 constituting the sensor portion SP becomes larger than the diameter al of the cores 21 of the optical fibers (20a, 20b) in this configuration.

As shown in FIG. 3B, in place of the hetero core portion, the sensor portion SP can be constituted so that a light transmission member 30 having a refractive index equivalent to the refractive index of the core 21 of the optical fiber (20a, 20b) or the refractive index of the cladding 22 is joined to the middle portion of the optical fibers (20a, 20b) as well.

The above sensor portion can be set at a variety of locations in accordance with the application.

For example, in a case of use in a security system of a building etc., opening/closing information of doors, windows, and other opening portions can be obtained in a building into which the optical fiber communication line is led. Further, in a case of use in an environment monitoring system etc., rainfall and snowfall in a forest or other natural environment in which the sensor line is laid, waterlevels of underground water and wetlands, wind pressure, growth information of plants, and other environmental information can be obtained. Alternatively, in a case laid in a tunnel, bridge, or other structures, cracks, distortion, and other structural information of the structure can be obtained.

In a sensor portion having the above structure, for example, the intensity of the optical signal transmitted by the connection to the sensor line falls by 1 dB. It further falls by about 1 dB at the time of ON/OFF switching of the sensor portion.

Namely, even if connecting five sensor portions having the constitution described above in series on the sensor line, the loss of transmission is about 5 to 10 dB. Therefore, so far as the allowable signal intensity of the connection apparatus 12 etc. is 5 to 10 dB, no particular problem occurs even when for example connecting five sensor portions in series.

Four sensor portions are connected in the drawing. Naturally, a number other than that described above is possible. A constitution providing just one may be employed as well.

Further, sensor portions may be arranged on the optical fibers at portions shared by the optical fiber sensor line and the communication line or may be arranged on the sensor line after branching from the communication line.

As described above, the optical fiber sensor according to the present embodiment has an optical fiber sensor line being a single mode type optical fiber provided with a core and with a cladding provided on the outer circumference of the core, and provided so as to be optically coupled with an optical fiber communication line, which has a sensor portion enabling interaction of a portion of the transmitted light with the external environment and including a portion for transmitting at least communication light from the optical fiber communication line; a light source emitting sensor light to the incident end of the optical fiber sensor line; and a light receiving portion detecting the sensor light emitted from the emitting end of the optical fiber sensor line via the sensor portion.

Accordingly, according to the optical fiber sensor of the present embodiment, the optical fiber sensor can be used on an optical fiber communication line of the Internet etc., and the communication line and sensor line can be shared.

Further, in the case where the optical fiber sensor is used on an optical fiber communication line of the Internet etc., it becomes possible to extract the output of the sensor from the optical fiber communication line. For example, when applied to a security system, it becomes possible to manage the security information on the Internet. For example, an Internet provider can utilize existing equipment and easily run a security management business for its Internet subscribers.

Further, in the case of environment monitoring and building monitoring as well, a region where the optical fiber communication line is already laid can be easily made the monitor region described above.

### Second Embodiment

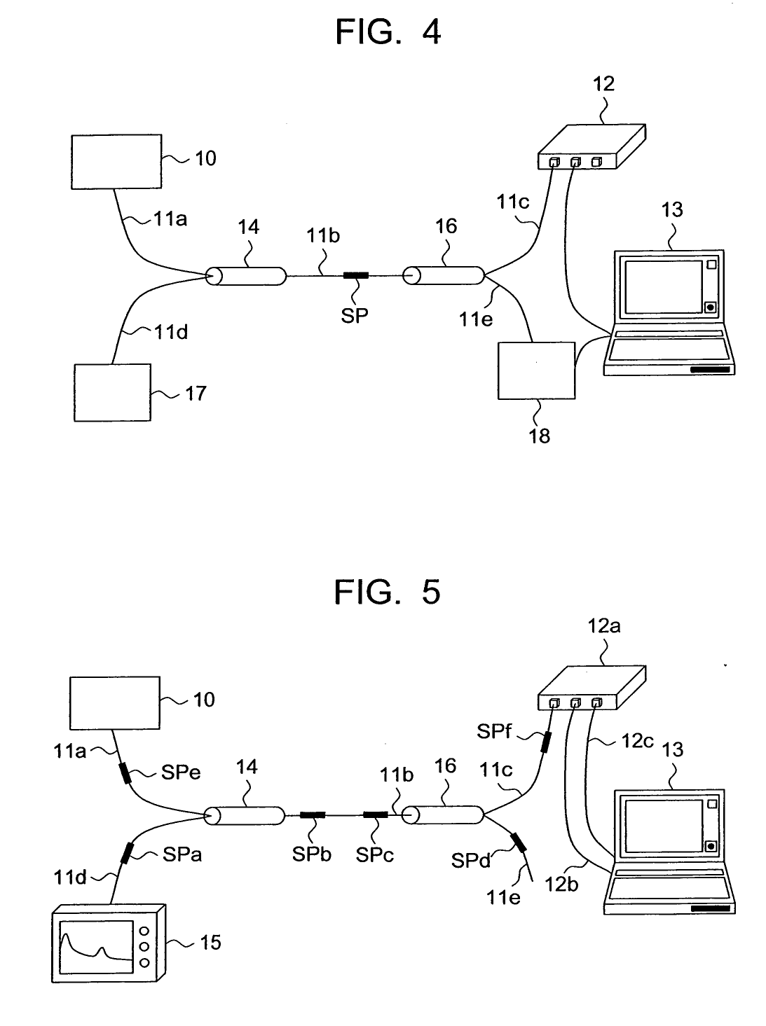

FIG. 4 is a schematic view of the configuration of an optical fiber sensor connected to an optical fiber communication line according to the present embodiment.

In the same way as the first embodiment, for example, a first optical fiber 11a, second optical fiber 11b, and third optical fiber 11c are provided connected to the Internet 10, whereby an optical fiber communication line is formed. A connection apparatus 12 and personal computer 13 are provided connected to this.

Further, the optical coupler 14 is provided in the connection portion of the first optical fiber 11a and second optical fiber 11b, the fourth optical fiber 11d is connected, and a laser diode, light emitting diode, or other light source 17 is connected.

Further, an optical splitter 16 is provided in the connection portion of the second optical fiber 11b and third optical fiber 11c, and a fifth optical fiber 11e is connected. To the fifth optical fiber 11e is connected a photodiode or other light receiving portion 18.

Here, on the second optical fiber 11b, a sensor portion SP having the same constitution as that in the first embodiment is provided. The fourth optical fiber 11d, second optical fiber 11b, and fifth optical fiber 11e constitute the optical fiber sensor line. Namely, the second optical fiber 11b is shared by the optical fiber communication line and optical fiber sensor line in this constitution.

The light source 17 emits sensor light having a wavelength of for example 1.55 μm and makes this strike the incident end of the fourth optical fiber 11d.

The sensor light is combined with the communication light transmitted from the first optical fiber 11a at the optical coupler 14 and transmitted to the second optical fiber 11b.

After the combined sensor light and communication light is transmitted through the second optical fiber 11b, the optical splitter 16 transmits the sensor light to the fifth optical fiber 11e side. This is received at the light receiving portion 18. The sensor information changed to an electric signal at the light receiving portion 18 is input to for example a personal computer 13 and subjected to predetermined information processing.

On the other hand, the communication light is transmitted to the connection apparatus 12 through the third optical fiber 11c.

From the information of the sensor light received at the light receiving portion as described above, in the same way as the first embodiment, security information, environment information, or building information or other information to be measured in the sensor portion SP are obtained.

In the present embodiment, one sensor portion is arranged on one optical fiber sensor line, but a plurality of sensor portions may be arranged as well in the same way as the first embodiment. Note, the information obtained at the light receiving portion 18 becomes information combining the information of sensor lights by the sensor portions. Therefore, this can be applied in a case where from which sensor portion the information comes is unclear. Alternatively, by setting a loss of a difference between the on state and off state of each sensor at different values, irrespective of combined information, from which sensor the information comes can be sometimes discriminated.

As described above, the optical fiber sensor according to the present embodiment has an optical fiber sensor line being a single mode type optical fiber provided with a core and with a cladding provided on the outer circumference of the core and provided so as to be optically coupled with an optical fiber communication line, which has a sensor portion enabling interaction of a portion of the transmitted light with the external environment and including a portion for transmitting at least communication light from the optical fiber communication line; a light source emitting sensor light to the incident end of the optical fiber sensor line; and a light receiving portion detecting the sensor light emitted from the emitting end of the optical fiber sensor line via the sensor portion.

Accordingly, according to the optical fiber sensor of the present embodiment, the optical fiber sensor can be used on optical fiber communication lines of the Internet etc., and the communication line and sensor line can be shared.

### Third Embodiment

FIG. 5 is a schematic view of the configuration of an optical fiber sensor connected to an optical fiber communication line according to the present embodiment.

This is configured as the optical fiber sensor shown in the first embodiment, wherein sensor portions (SPe, SPf) are further arranged on the first optical fiber 11a and third optical fiber 11c constituting the optical fiber communication line.

In this case, only communication lights are transmitted to the first optical fiber 11a and third optical fiber 11c. These communication lights become sensor lights as they are with respect to sensor portions (SPe, SPf). Namely, the Internet 10 becomes the light source itself, and communication lights transmitted from the Internet 10 are used well as sensor lights as they are.

Communication lights (sensor lights) passed through the sensor portions (SPe, SPf) are received at a media converter or modem or other connection apparatus 12a. Here, the connection apparatus 12a is configured so that, unlike the first embodiment, not only is digital processing of received communication light (sensor light) performed to obtain the communication signal, but also the monitoring of the intensity of the communication light (sensor light) is enabled, and the sensor signal is obtained by grasping the change of intensity thereof. The communication signal obtained in this way is input to the personal computer 13 by a communication cable 12b and the transfer of information is carried out together with a server on the Internet. On the other hand, the sensor signal is input to the personal computer 13 by a sensor cable 12c and subjected to the predetermined information processing.

As described above, from the information of the sensor light received at the connection apparatus 12a, in the same way as the first embodiment, the security information, environment information or building information and other information to be measured at the sensor portions SP are obtained.

In the present embodiment as well, in the same way as the first and second embodiments, a plurality of sensor portions may be provided on the optical fiber sensor line or just one sensor portion may be arranged. Note, in the case of a plurality of sensor portions, the obtained information becomes information combining the information of the plurality of sensor portions.

As described above, the optical fiber sensor according to the present embodiment has an optical fiber sensor line being a single mode type optical fiber provided with a core and with a cladding provided on the outer circumference of the core and provided so as to be optically coupled with an optical fiber communication line, which has a sensor portion enabling interaction of a portion of the transmitted light with the external environment and including a portion for transmitting at least communication light from the optical fiber communication line; a light source emitting sensor light to the incident end of the optical fiber sensor line; and a light receiving portion detecting the sensor light emitted from the emitting end of the optical fiber sensor line via the sensor portion.

Accordingly, according to the optical fiber sensor of the present embodiment, the optical fiber sensor can be used on optical fiber communication lines of the Internet etc., and the communication line and sensor line can be shared.

The present invention is not limited to the above explanation.

For example, in the above embodiment, there is no restriction on the number of sensor portions connected to the sensor line. The number may be one or many. In particular, in the constitution connecting the ODTR measurement unit, it is possible to obtain the information obtained at sensor portions by discriminating a plurality of sensor portions.

Other than these, various modifications are possible within a range not out of the gist of the present invention.

### INDUSTRIAL APPLICABILITY

The optical fiber sensor connected to the optical fiber communication line of the present invention can be applied as an optical fiber sensor constructing a security system, environment monitoring system, structure monitoring system, and so on.

1. An optical fiber sensor connected to an optical fiber communication line comprising:
an optical fiber sensor line being an optical fiber provided with a core and with a cladding provided on an outer circumference of the core and provided so as to be optically coupled with the optical fiber communication line, which has a sensor portion for enabling interaction of a portion of transmitted light with an external environment and includes a portion for transmitting at least communication light from said optical fiber communication line;
a light source emitting sensor light to an incident end of the optical fiber sensor line; and
a light receiving portion detecting said sensor light emitted from an emitting end of said optical fiber sensor line via said sensor portion.

2. An optical fiber sensor as set forth in claim 1, wherein said sensor portion is a hetero core portion having a core diameter different from the core diameter of the optical fiber and is joined to a middle portion of the optical fibers.

3. An optical fiber sensor as set forth in claim 1, wherein the sensor portion is configured having a light transmission member having a refractive index equivalent to the refractive index of the core of the optical fibers or the refractive index of the cladding joined to the middle portion of the optical fibers.

4. An optical fiber sensor as set forth in claim 1, further having on the optical fiber sensor line an optical coupler for combining the sensor light from the light source and the communication light from the optical fiber communication line.

5. An optical fiber sensor as set forth in claim 4, wherein wavelengths of the communication light and the sensor light are different.

6. An optical fiber sensor as set forth in claim 1, further having on the optical fiber sensor line an optical splitter for splitting the light, sending the sensor light to the light receiving portion, and sending the communication light to a communication apparatus.

7. An optical fiber sensor as set forth in claim 1, wherein the incident end and emitting end are the same end portion of the optical fibers, and the light receiving portion detects backward scattering light from the sensor portion.

8. An optical fiber sensor as set forth in claim 1, wherein the optical fiber communication line is the Internet.

9. An optical fiber sensor as set forth in claim 1, wherein the optical fiber communication line is used as the light source, and the communication light from the optical fiber communication line is used as it is as the sensor light.

10. An optical fiber sensor as set forth in claim 2, further having on the optical fiber sensor line an optical coupler for combining the sensor light from the light source and the communication light from the optical fiber communication line.

11. An optical fiber sensor as set forth in claim 3, further having on the optical fiber sensor line an optical coupler for combining the sensor light from the light source and the communication light from the optical fiber communication line.

12. An optical fiber sensor as set forth in claim 2, further having on the optical fiber sensor line an optical splitter for splitting the light, sending the sensor light to the light receiving portion, and sending the communication light to a communication apparatus.

13. An optical fiber sensor as set forth in claim 3, further having on the optical fiber sensor line an optical splitter for splitting the light, sending the sensor light to the light receiving portion, and sending the communication light to a communication apparatus.

14. An optical fiber sensor as set forth in claim 4, further having on the optical fiber sensor line an optical splitter for splitting the light, sending the sensor light to the light receiving portion, and sending the communication light to a communication apparatus.

15. An optical fiber sensor as set forth in claim 5, further having on the optical fiber sensor line an optical splitter for splitting the light, sending the sensor light to the light receiving portion, and sending the communication light to a communication apparatus.

16. An optical fiber sensor as set forth in claim 2, wherein the incident end and emitting end are the same end portion of the optical fibers, and the light receiving portion detects backward scattering light from the sensor portion.

17. An optical fiber sensor as set forth in claim 3, wherein the incident end and emitting end are the same end portion of the optical fibers, and the light receiving portion detects backward scattering light from the sensor portion.

18. An optical fiber sensor as set forth in claim 4, wherein the incident end and emitting end are the same end portion of the optical fibers, and the light receiving portion detects backward scattering light from the sensor portion.

19. An optical fiber sensor as set forth in claim 5, wherein the incident end and emitting end are the same end portion of the optical fibers, and the light receiving portion detects backward scattering light from the sensor portion.

20. An optical fiber sensor as set forth in claim 2, wherein the optical fiber communication line is the Internet.
